(19) United States
(12) Patent Application Publication
(10) Pub. No.: US 2025/0103200 A1
(43) Pub. Date: Mar. 27, 2025

(54) PLAYBACK APPARATUS, CONTROL METHOD, AND STORAGE MEDIUM

(71) Applicant: CANON KABUSHIKI KAISHA, Tokyo (JP)

(72) Inventor: TAKU OGASAWARA, Tokyo (JP)

(21) Appl. No.: 18/896,543

(22) Filed: Sep. 25, 2024

(30) Foreign Application Priority Data
Sep. 27, 2023 (JP) 2023-166367

(51) Int. Cl. G06F 3/0487; G06F 3/04815; G06F 3/0484; G06T 15/20

(52) U.S. Cl. CPC G06F 3/0487; G06F 3/04815; G06F 3/0484; G06T 15/205; G06T 2200/24

(57) ABSTRACT

A playback apparatus includes one or more memories storing instructions, and one or more processors executing the instructions to play back a virtual viewpoint image from a predetermined start timecode to a predetermined end timecode, the virtual viewpoint image being generated using three-dimensional shape data generated from images captured from a plurality of positions and virtual viewpoint information, control the virtual viewpoint information, and initialize timecode of the virtual viewpoint image to the predetermined start timecode in response to an end of playback of the virtual viewpoint image, wherein the virtual viewpoint information is controlled differently in playing back the virtual viewpoint image and in initializing the timecode.

### BACKGROUND

### Field of the Disclosure

The present disclosure relates to a playback apparatus that displays a virtual viewpoint image.

### Description of the Related Art

A virtual viewpoint image generation technique that can generate an image seen from any given point of view using a plurality of images captured by a plurality of cameras has been attracting attention in recent years.

A given point of view used to generate a virtual viewpoint image is called virtual point of view (virtual camera). Unlike physical cameras, virtual cameras are free from physical constraints and can make various motions including translation and rotation in a virtual three-dimensional space.

Japanese Patent No. 6419278 discusses a method for controlling various actions of a virtual camera based on the number of fingers making a tap operation on a touchscreen in a configuration where an image display apparatus including the touchscreen displays a virtual viewpoint image.

In the configuration discussed in Japanese Patent No. 6419278, each user has his/her own device and can intuitively operate the virtual camera and timecode to view a virtual viewpoint image. This enables users who are not accustomed to virtual viewpoint images to view a virtual viewpoint image at exhibitions where the virtual viewpoint image is exhibited. For example, at an exhibition, a virtual viewpoint image repeating a particular scene can be exhibited so that users can experience viewing the virtual viewpoint image and enjoy the same scene from different points of view. Such exhibition enables the users to freely move the virtual camera while viewing the virtual viewpoint image.

With the technique discussed in Japanese Patent No. 6419278, a large number of users at an exhibition take turns to view on a single device, for example. However, it has been troublesome for the staff to restore the virtual camera of the virtual viewpoint image to a predetermined initial position after each user's viewing.

### SUMMARY

According to an aspect of the present disclosure, a playback apparatus includes one or more memories storing instructions, and one or more processors executing the instructions to play back a virtual viewpoint image from a predetermined start timecode to a predetermined end timecode, the virtual viewpoint image being generated using three-dimensional shape data generated from images captured from a plurality of positions and virtual viewpoint information, control the virtual viewpoint information, and initialize timecode of the virtual viewpoint image to the predetermined start timecode in response to an end of playback of the virtual viewpoint image, wherein the virtual viewpoint information is controlled differently in playing back the virtual viewpoint image and in initializing the timecode.

Further features of the present disclosure will become apparent from the following description of exemplary embodiments with reference to the attached drawings.

### BRIEF DESCRIPTION OF THE DRAWINGS

FIGS. 1A and 1B are examples of configuration diagrams of a virtual viewpoint image generation system.

FIGS. 2A and 2B are examples of block diagrams of an image display apparatus.

FIGS. 3A to 3D are diagrams for describing the position, orientation, and a point of interest of a virtual camera.

FIG. 4 illustrates an example of an operation screen of the image display apparatus.

FIGS. 5A and 5B are diagrams illustrating an example of a configuration of a database.

FIG. 6 is a flowchart illustrating an example of playback processing of a virtual viewpoint image according to one or more aspects of the present disclosure.

FIGS. 7A to 7G illustrate display examples of a virtual viewpoint image according to one or more aspects of the present disclosure.

FIG. 8 is a flowchart illustrating an example of playback processing of a virtual viewpoint image according to one or more aspects of the present disclosure.

FIGS. 9A to 9B illustrate display examples of a virtual viewpoint image according to one or more aspects of the present disclosure.

### DESCRIPTION OF THE EMBODIMENTS

Exemplary embodiments of the present disclosure will be described below with reference to the drawings. The following exemplary embodiments demonstrate specific examples of embodiment of the present disclosure and are not restrictive.

A first exemplary embodiment deals with playback processing of a virtual viewpoint image in a system that plays back a virtual viewpoint image, applied in exhibitions in particular.

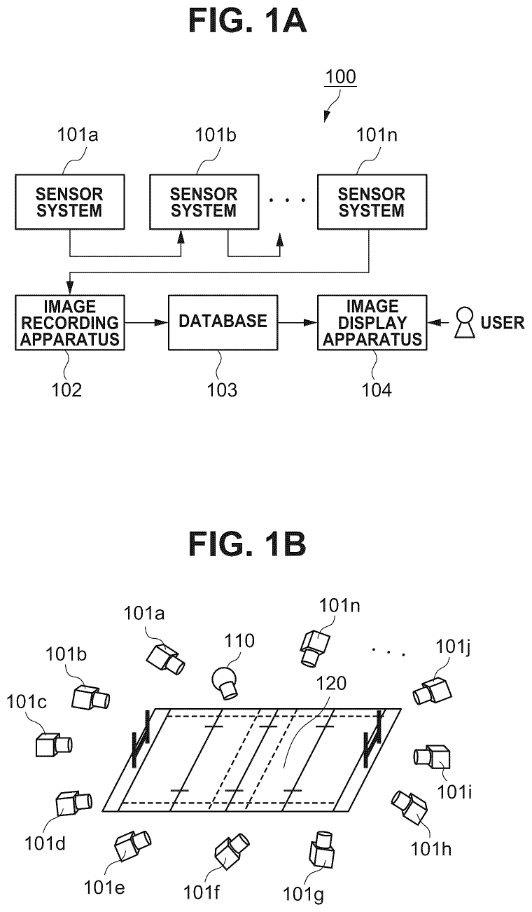

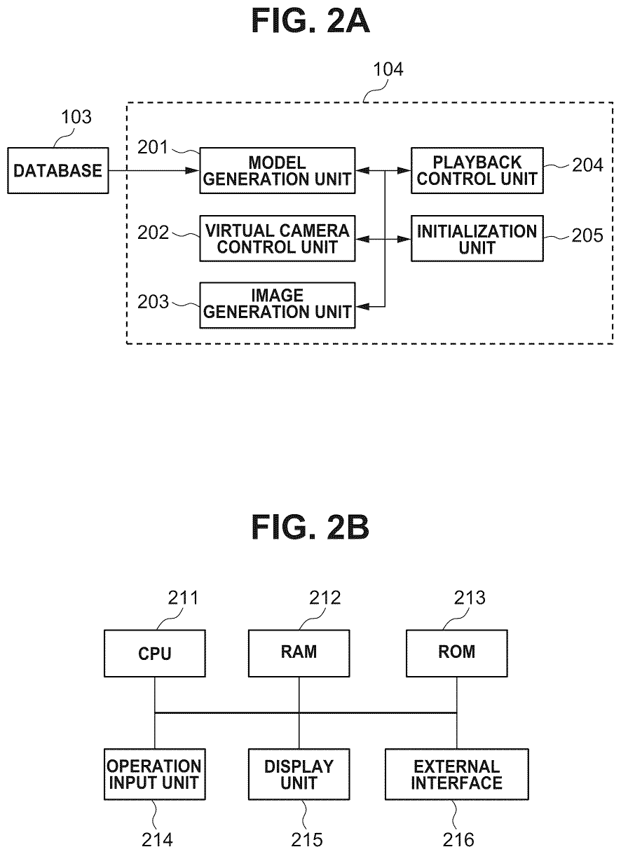

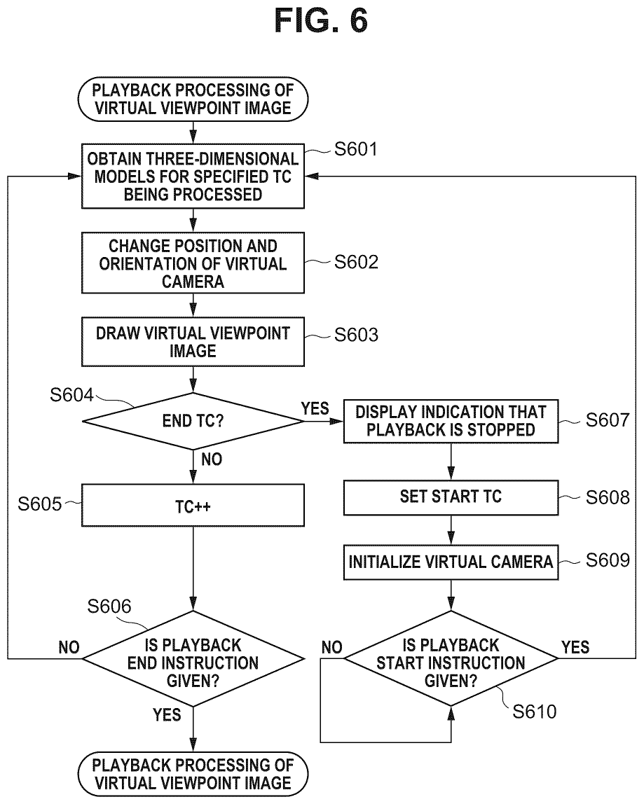

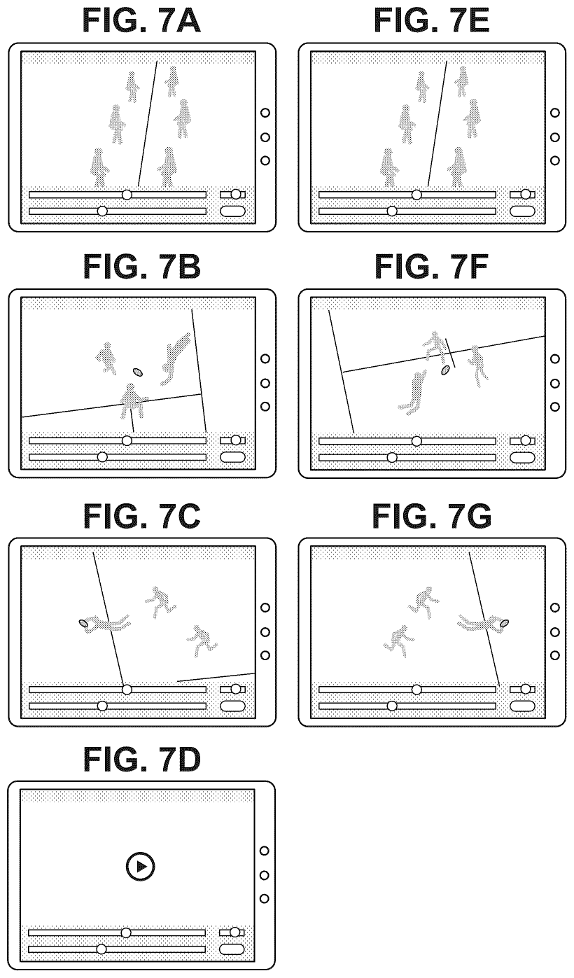

FIGS. 1A and 1B illustrate an entire virtual viewpoint image generation system. FIGS. 2A and 2B illustrate an image display apparatus 104 therein. The image display apparatus 104 performs the playback processing of a virtual viewpoint image that is a feature of the present exemplary embodiment. The playback processing will be described with reference to FIG. 6. A playback example will be described with reference to FIGS. 7A to 7G.

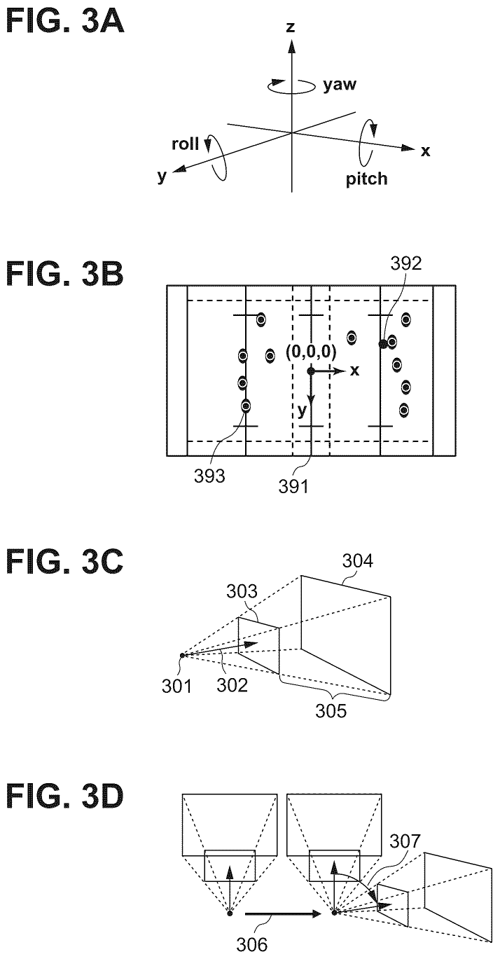

FIG. 3A to 5B illustrate an operation method of a virtual camera and a database for describing the playback processing of a virtual viewpoint image.

### (Configuration of Virtual Viewpoint Image Generation System)

FIGS. 1A and 1B illustrate a configuration of a virtual viewpoint image generation system 100 according to the present exemplary embodiment.

FIG. 1A is a block diagram illustrating a configuration example of the virtual viewpoint image generation system 100.

The virtual viewpoint image generation system 100 includes n sensor systems, or a sensor system 101a to a sensor system 101n. Each sensor system includes at least one imaging apparatus, or camera. The n sensor systems will hereinafter be referred to as a plurality of sensor systems 101 without distinction, unless otherwise specified.

FIG. 1B is a diagram illustrating an installation example of the plurality of sensor systems 101. The plurality of sensor systems 101 is installed to surround an area 120 to be imaged and captures images of the area 120 in respective different directions.

In the example illustrated in FIGS. 1A and 1B, the area 120 to be imaged is the field of a stadium where rugby or other sports matches are held, and the n (for example, 100) sensor systems 101 are installed to surround the field. The number of sensor systems 101 installed is not limited in particular. The area 120 to be imaged is not limited to the stadium field, either. The area 120 may include the stadium's spectator seats. The area 120 may be an indoor studio or a stage.

The plurality of sensor systems 101 does not need to be installed all around the area 120, and may be installed only partly around the area 120 due to restrictions on installation locations. The cameras included in the plurality of sensor systems 101 may include imaging apparatuses with different functions, such as telephoto cameras and wide-angle cameras.

The plurality of sensor systems 101, or plurality of cameras, captures images in a synchronous manner. A plurality of images captured will be referred to as multi-view images.

Each of the multi-view images according to the present exemplary embodiment may be a captured image or an image obtained by performing image processing, such as processing for extracting a predetermined region, on the captured image.

Each sensor system 101 may include a microphone (not illustrated) in addition to the camera.

Each microphone in the plurality of sensor systems 101 collects audio and generates audio signal. The generated audio signals are recorded in a time-synchronized manner. An acoustic signal to be played back with image display on an image display apparatus 104 can be generated based on the collected audio signals. For the sake of simplicity, the description of audio will hereinafter be omitted, whereas images and audio are basically processed in parallel.

The sensor systems 101 capture images during a target event, and three-dimensional models are generated using the multi-view images. If, for example, the target event is a rugby match, three-dimensional models of subjects such as players and referees are generated and recorded from the start of the match (kickoff) to the end of the match (no-side).

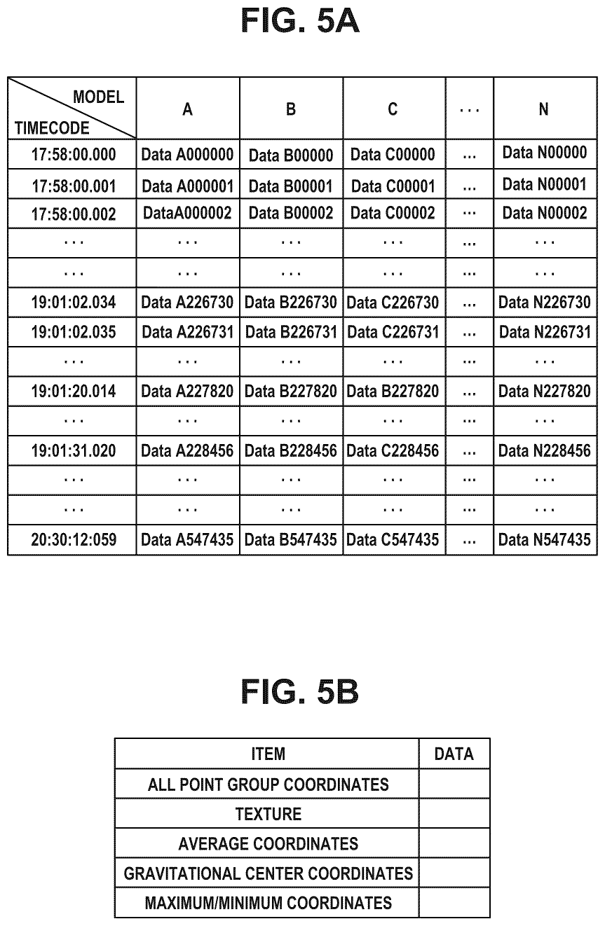

An image recording apparatus 102 obtains the three-dimensional models generated using the multi-view images obtained from the plurality of sensor systems 101, and stores the three-dimensional models in a database 103 along with the timecodes used in capturing the images. The configuration of this database 103 will be described below with reference to FIGS. 5A and 5B.

A timecode (hereinafter, also referred to as TC) is information for uniquely identifying the time at which an image is captured. For example, a timecode is expressed in the format of “day: hour: minute: second.frame number”. In the present exemplary embodiment, the three-dimensional models of the subjects are generated for all TCs during imaging.

The image display apparatus 104 generates a virtual viewpoint image with the multi-view images for each TC obtained from the database 103 and user operations on a virtual camera as inputs.

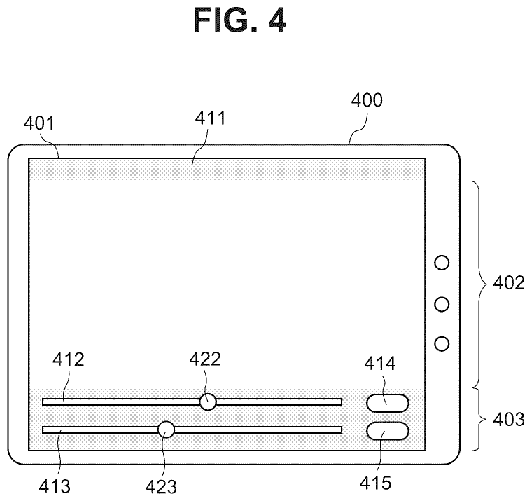

The virtual camera is set within a virtual space associated with the area 120. Using the virtual camera, the area 120 can be viewed from a point of view different from any of the cameras of the plurality of sensor systems 101. The point of view defined by the position and orientation of this virtual camera will be referred to as a virtual point of view. Data including the position and orientation of the virtual camera is an example of virtual viewpoint information. A virtual camera 110 and details of its operation will be described below with reference to FIGS. 3A to 3D. An operation screen will be described below with reference to FIG. 4.

The image display apparatus 104 performs the playback processing of a virtual viewpoint image to generate a virtual viewpoint image using three-dimensional models specified by a timecode and the virtual camera 110. The playback processing will be described in detail below with reference to FIG. 6. A playback example will be described in detail below with reference to FIGS. 7A to 7G.

The virtual viewpoint image generated by the image display apparatus 104 is an image showing the view from the virtual camera 110. The virtual viewpoint image according to the exemplary embodiment is also referred to as a free viewpoint video image. The virtual viewpoint image is displayed on a touchscreen or a liquid crystal display of the image display apparatus 104.

The configuration of the virtual viewpoint image generation system 100 is not limited to that illustrated in FIGS. 1A and 1B. The image display apparatus 104 may be configured separate from the operation device or the display device. A plurality of display devices may be connected to the image display apparatus 104, and a virtual viewpoint image may be output to each of the display devices.

The database 103 and the image display apparatus 104 may be integrally configured.

The virtual viewpoint image generation system 100 may be configured so that only important scenes are copied from the database 103 to the image display apparatus 104 in advance. Whether to enable access to all the TCs of the match or only some of the TCs may be switched depending on the configuration.

### (Functional Configuration of Image Display Apparatus)

A configuration of the image display apparatus 104 will be described with reference to FIGS. 2A and 2B.

FIG. 2A is a block diagram illustrating a functional configuration example of the image display apparatus 104. A playback control unit 204 plays a central role in performing the playback processing of a virtual viewpoint image that is a feature of the present disclosure.

The functional blocks will be described in order.

A model generation unit 201 specifies a TC and generates three-dimensional models (three-dimensional shape data) expressing the three-dimensional shapes of subjects from the multi-view images obtained from the database 103. The model generation unit 201 initially obtains foreground images and background images. The foreground images are extracted from the multi-view images and include foreground regions such as human figures and a ball included in the subjects. The background images are extracted from the multi-view images and include background regions other than the foreground regions. The model generation unit 201 then generates foreground three-dimensional models using the plurality of foreground images obtained. For example, such processing is performed using shape estimation methods such as visual hull, and the three-dimensional models are obtained as point groups. The format of three-dimensional models expressing object shapes is not limited thereto.

The model generation unit 201 may be included in the image recording apparatus 102 instead of the image display apparatus 104. In such a case, the three-dimensional models generated by the image recording apparatus 102 are recorded into the database 103, and the image display apparatus 104 is configured to read the three-dimensional models from the database 103.

The coordinates of the foreground three-dimensional model of each object, such as a ball and a human figure, may be calculated and accumulated in the database 103. The coordinates of the background three-dimensional models may be obtained by an external apparatus in advance.

A virtual camera control unit 202 obtains input information that the user operates for the virtual camera 110, and operates the position and orientation of the virtual camera 110. Examples of the operation device for the virtual camera 110 include a touchscreen and a joystick. The operation device is not limited thereto.

The virtual camera control unit 202 can control the position and orientation of the virtual camera 110 depending on the processing on the virtual viewpoint image. The position and orientation of the virtual camera 110 will be described below with reference to FIGS. 3A to 3D. The operation screen will be described below with reference to FIG. 4.

An image generation unit 203 generates a virtual viewpoint image using the position and orientation of the virtual camera 110 and the three-dimensional models. Specifically, the image generation unit 203 obtains an appropriate pixel value for each of the points constituting the three-dimensional models from the multi-view images and performs coloring processing. The image generation unit 203 then generates the virtual viewpoint image by laying out the colored three-dimensional models in the three-dimensional virtual space, projecting the layout upon the virtual point of view, and rendering the resultant.

The method for generating the virtual viewpoint image is not limited thereto. Various methods can be used, including a method for generating a virtual viewpoint image through projective transformation of captured images without using three-dimensional models.

An initialization unit 205 manages the initial values of the position and orientation of the virtual camera 110, a predetermined start timecode (start TC), and a predetermined end timecode (end TC), and sets initial values using the managed values. The processing for setting the initial values will be referred to as initialization. The position and orientation of the virtual camera 110 will be described below with reference to FIGS. 3A to 3D. The predetermined start and end TCs will be described below with reference to FIGS. 5A and 5B. The start and end TCs to be managed are not limited to a single pair, and a plurality of pairs may be managed.

The playback control unit 204 plays back the virtual viewpoint image as a moving image using the processing units described above. The playback processing of the virtual viewpoint image will be described below with reference to the flowchart of FIG. 6. A playback example will be described with reference to FIGS. 7A to 7G.

### (Hardware Configuration of Image Display Apparatus)

Next, a hardware configuration of the image display apparatus 104 will be described. FIG. 2B is a diagram illustrating a hardware configuration example of the image display apparatus 104.

A central processing unit (CPU) 211 performs processing using programs and data stored in a random access memory (RAM) 212 and a read-only memory (ROM) 213.

The CPU 211 controls operation of the entire image display apparatus 104 and executes processing for implementing the functions illustrated in FIG. 2A. The image display apparatus 104 may include one or more pieces of dedicated hardware other than the CPU 211, and the dedicated hardware may perform at least part of the processing of the CPU 211. Examples of the dedicated hardware include an application-specific integrated circuit (ASIC), a field-programmable gate array (FPGA), and a digital signal processor (DSP).

The ROM 213 stores programs and data. The RAM 212 includes a work area for temporarily storing the programs and data read from the ROM 213. The RAM 212 also provides a work area for the CPU 211 to use in performing various types of processing.

An operation input unit 214 obtains information that the user operates using the touchscreen, for example. In the present exemplary embodiment, the operation input unit 214 accepts operations on the virtual camera 110 and the timecode. The operation input unit 214 may be connected to an external controller and accept input information about operations. Examples of the external controller include a three-axis controller such as a joystick, and a mouse. The external controller is not limited thereto.

A display unit 215 displays the generated virtual viewpoint image on the touchscreen or a monitor screen.

In the case of the touchscreen, the operation input unit 214 and the display unit 215 are integrally configured.

An external interface 216 transmits and receives information to/from the database 103 via a local area network (LAN), for example. The external interface 216 may transmit information to an external screen via an image output port such as a High-Definition Multimedia Interface (HDMI) (registered trademark) port and a serial digital interface (SDI) port. The external interface 216 may transmit image data via Ethernet.

### (Position and Orientation of Virtual Camera)

The virtual camera 110 (or virtual point of view) will be described with reference to FIGS. 3A to 3D.

The position and orientation of the virtual camera 110 are specified using a given coordinate system. In the present exemplary embodiment, a typical three-dimensional orthogonal coordinate system with X-, Y-, and Z-axes illustrated in FIG. 3A is used.

This coordinate system is set and used for a subject. The subject here refers to a stadium field or a studio. As illustrated in FIG. 3B, the subject includes an entire stadium field 391, and a ball 392 and players 393 thereon. The subject may include spectator seats around the field 391.

The coordinate system for the subject is set with the center of the field 391 as a point of origin (0, 0, 0).

The X-axis refers to the long-side direction of the field 391, the Y-axis the short-side direction of the field 391, and the Z-axis the vertical direction to the field 391. Note that the settings of the coordinate system are not limited thereto.

Next, the virtual camera 110 will be described with reference to FIGS. 3C and 3D.

FIG. 3C illustrates a pyramid, the vertex of which indicates a position 301 of the virtual camera 110 and the vector extending from the vertex indicates orientation 302 of the virtual camera 110. The position 301 of the virtual camera 110 is expressed by coordinates (x, y, z) in the three-dimensional space. Orientation is a unit vector with the components on the respective axes as scalars.

The orientation 302 of the virtual camera 110 passes through the center positions of a front clipping plane 303 and a rear clipping plane 304. A space 305 between the front clipping plane 303 and the rear clipping plane 304 will be referred to as a view frustrum of the virtual camera 110. The view frustrum represents the range where the image generation unit 203 generates a virtual viewpoint image (or the range where a virtual viewpoint image is projected and displayed; hereinafter, referred to as a display range of the virtual viewpoint image).

The vector indicating the orientation 302 of the virtual camera 110 may also be referred to as an optical axis vector of the virtual camera 110.

The initial values of the virtual camera 110 used in the present exemplary embodiment refer to the initial values of the position 301 and orientation 302 of the virtual camera 110.

The initial value of the position 301 indicates a predetermined point in the three-dimensional space. The initial value of the orientation 302 is a predetermined unit vector in the three-dimensional space. For example, the position 301 is set at (x1, y1, z1), and orientation is set at (x2, y2, z2). The initial values of the virtual camera 110 may include a focal length aside from the position and orientation.

With the initial values of the virtual camera 110 set, the virtual viewpoint image generated using the virtual camera 110 includes a predetermined area of the subject. The same virtual viewpoint image can thus be obtained each time the initial values are set. A specific example of the virtual viewpoint image when the initial values of the virtual camera 110 are set will be described below with reference to FIGS. 7A to 7G.

The translation and rotation of the virtual camera 110 will be described with reference to FIG. 3D. The virtual camera 110 translates and rotates in the space expressed by the three-dimensional coordinates. A translation 306 of the virtual camera 110 represents the movement of the position 301 of the virtual camera 110. The components of the position 301 on the respective X-, Y-, and Z-axes are expressed by x, y, and z, respectively. As illustrated in FIG. 3A, a rotation 307 of the virtual camera 110 is expressed by Euler angles consisting of the following three angles: yaw that is rotation about the Z-axis, pitch that is rotation about the X-axis, and roll that is rotation about the Y-axis. The three rotation angles may hereinafter be collectively denoted like (yaw_1, pitch_1, roll_1), for example. The three angles are each expressed in radians or degrees. The representation of rotation is not limited to Euler angles, and quaternions may be used.

The virtual camera 110 can thus translate and rotate freely in the three-dimensional space of the subject (field) to generate a virtual viewpoint image of a given area of the subject.

### (Operation Screen)

A method for operating the virtual camera 110 and a method for operating the timecode will be described with reference to FIG. 4.

FIG. 4 illustrates an operation screen 401 of a tablet 400 that combines the same operation input unit 214 and display unit 215 of the image display apparatus 104. As illustrated in FIG. 4, the operation screen 401 is mainly composed of two areas: a virtual camera operation area 402 and a timecode display area 403. The virtual camera operation area 402 accepts operations on the virtual camera 110. The timecode display area 403 provides TC-related display.

The method for operating the virtual camera 110 is a conventional technique, and details thereof will thus be omitted. For example, if the operation input unit 214 is a touchscreen, the operations on the position and orientation of the virtual camera 110 described with reference to FIGS. 3A to 3D are assigned depending on the number of fingers used to touch the virtual camera operation area 402, whereby each parameter can be freely operated.

Next, the timecode display area 403 will be described. The timecode display area 403 includes components 412 to 415, 422, and 423 for checking and operating timecode.

A main slider 412 displays the lapse of the overall timecode of the captured data.

A sub slider 413 can enlarge a part of the overall timecode to display timecodes in detail. The main slider 412 and the sub slider 413 have the same length onscreen but display different widths of timecode. For example, the main slider 412 can display the duration of a match, or three hours, and the sub slider 413 can display a part of the duration, 30 seconds. In other words, the sliders are on different scales. The sub slider 413 can provide more detailed TC display, like in units of frames.

The TC indicated using a handle 422 on the main slider 412 and the TC indicated using a handle 423 on the sub slider 413 may be numerically displayed in a format such as “day: hour: minute: second.frame number”.

The sub slider 413 does not need to be displayed all the time. The timecode interval that can be displayed by the sub slider 413 may be variable.

A playback button 414 is used to start and end the playback processing, and functions as a toggle button to provide both instructions. The playback start and end instructions will be described below with reference to FIG. 6.

An initialization setting button 415 is a button for making settings about the initialization of the virtual camera 110.

The operation screen may include areas other than the virtual camera operation area 402 and the timecode display area 403. For example, match information may be displayed on an area 411 at the top of the screen. Examples of the match information include the venue, the date and time, the matchup, and the score.

The area 411 at the top of the screen may be assigned exceptional operations. For example, if the area 411 at the top of the screen accepts a double-tap, it may be considered as an operation for moving the position and orientation of the virtual camera 110 to where the entire subject can be viewed in a bird's eye view. Inexperienced users may have difficulty in operating the virtual camera 110 and can get lost about where the virtual camera 110 is. In such a case, an operation to return to the bird's eye view point where the user can easily find out the position and orientation may be assigned to the area 411. A bird's eye view image is a virtual viewpoint image where the subject is viewed from above along the Z-axis as illustrated in FIG. 3B.

The configuration of the operation screen is not limited thereto, as long as the virtual camera 110 or the timecode can be operated. The virtual camera operation area 402 and the timecode display area 403 do not necessarily need to be separated.

While the operation input unit 214 and the display unit 215 are described to be implemented by the tablet 400, the operation and display devices are not limited thereto.

### (Database)

A table configuration of the database 103 storing the three-dimensional models generated from the multi-view images captured of the subject will be described with reference to FIGS. 5A and 5B.

FIG. 5A illustrates the table configuration, where all the timecodes (TCs) of the event to be imaged are arranged on the vertical axis, and three-dimensional model information on each object is listed along the horizontal axis.

The contents of the three-dimensional model information will be described with reference to FIG. 5B. The three-dimensional model information mainly includes the coordinates of each point in the point groups constituting the three-dimensional models, and texture images to be applied to the three-dimensional models. The three-dimensional model information is not limited thereto, and may include average coordinates, gravitational center coordinates, and the maximum and minimum values of the three-dimensional coordinates on each axis as representative values of the coordinates of all the points in the point groups. The three-dimensional models do not necessarily need to be separated object by object, and may be stored as a single piece of three-dimensional data for each TC.

In the example of FIG. 5A, a professional sports match such as a rugby or basketball match is captured, with approximately two and a half hours of TCs recorded from 17:58:00.000 to 20:20:12.059 for the single match. The framerate is 59.94 Hz, and three-dimensional models for approximately 550000 frames are recorded.

Using such a database, the image display apparatus 104 can obtain three-dimensional model information for a TC by specifying the TC. As described with reference to FIGS. 2A and 2B, the image display apparatus 104 can generate the virtual viewpoint image for the TC using the coordinates of all the point groups of the respective objects and the texture images included in the three-dimensional model information.

While all the TCs in the two and a half hours can be used, the image display apparatus 104 may select and use only some of the TCs. For example, if a scoring scene is captured in about 30 seconds from 19:01:02.034 to 19:01:31.020, the image display apparatus 104 can play back the virtual viewpoint image of only the scoring scene by using the frames between the start TC of 19:01:02.034 and the end TC of 19:01:31.020. The start TC and the end TC are data freely settable by the provider of the virtual viewpoint image.

The present exemplary embodiment assumes a case where only such a scoring scene is provided as a demonstration to a large number of users at an exhibition. The foregoing start and end TCs will be as an example in describing the playback processing and playback example of the virtual viewpoint image illustrated in FIGS. 6 and 7A to 7G. Note that the start and end TCs are not limited to the foregoing and can be any values within the entire TC range. A plurality of start TCs and end TCs may be set.

### (Playback Processing of Virtual Viewpoint Image)

The playback processing of the virtual viewpoint image, which is a feature of the present exemplary embodiment, will be described with reference to the flowchart of FIG. 6.

This processing is executed by the playback control unit 204 in the block diagram of FIG. 2 via other processing units.

The playback control unit 204 performs the loop processing of steps S601 to S610 in units of frames of the timecode. For example, if the virtual viewpoint image has a framerate of 59.94 frames per second (FPS), each loop (frame) is processed at intervals of approximately 16.6 [ms].

The framerate may be implemented by setting the refresh rate of the display that displays the image from the image display apparatus 104 to 59.94 FPS, and synchronizing the framerate with the refresh rate.

In this processing, the start and end TCs for the playback processing are set in advance.

For example, as described in conjunction with the example of the database 103 in FIGS. 5A and 5B, a start TC=19:01:02.034 and an end TC=19:01:31.020 are set in advance as a scoring scene in a professional sports match such as a rugby or basketball match. The period of approximately 30 seconds therebetween is used for the playback processing. The start and end TCs are not limited thereto, and any values can be set to set other scoring scenes as long as the TCs are recorded in the database 103.

Steps S601 to S610 will be described in order.

In step S601, the playback control unit 204 obtains three-dimensional models for the specified TC being processed from the database 103 via the model generation unit 201. As described with reference to FIGS. 5A and 5B, the database 103 manages three-dimensional models TC by TC.

In step S602, the playback control unit 204 accepts user operations on the virtual camera 110 and changes the position and orientation of the virtual camera 110 via the virtual camera control unit 202. As described with reference to FIGS. 3A to 3D, the user can freely operate the position and orientation of the virtual camera 110.

In step S603, the playback control unit 204 draws the virtual viewpoint image via the image generation unit 203, using the three-dimensional models obtained in step S601 and the virtual camera 110 operated up to the previous step. The method for drawing the virtual viewpoint image has been described with reference to FIGS. 2A and 2B. Drawing examples of the virtual viewpoint image will be described below with reference to the playback example of FIGS. 7A to 7G.

In step S604, the playback control unit 204 determines whether the TC being processed is the end TC. In this example, the playback control unit 204 determines whether the TC being processed is 19:01:31.020. If the determination is false (NO in step S604), the processing proceeds to step S605 and the user continues trying out the virtual viewpoint image. If the determination is true (YES in step S604), the processing proceeds to step S607 to display an indication onscreen that the playback is stopped (stopped state). Here, the viewing by one user ends. This branching process will be specifically described below using the playback display example of FIGS. 7A to 7G.

In step S605, the playback control unit 204 counts up the TC. The TC is counted up in units of frames. For each iteration of the loop processing of steps S601 to S609, the TC is counted up by one frame.

In step S606, the playback control unit 204 determines whether a playback end instruction is given. The presence or absence of the playback end instruction can be determined based on the toggle state of the playback button 414 illustrated in FIG. 4. If the determination is false (NO in step S606), the processing returns to step S601 to continue the playback processing. If the determination is true (YES in step S606), the playback processing ends.

In step S607, the playback control unit 204 displays the indication that the playback is stopped on the display unit of the image display apparatus 104. While the playback stop is displayed, any input operation on the virtual camera 110 is disabled. The user thereby figures out that his/her operation time is up. The display example during the stop will be described below with reference to FIG. 7D.

In step S608, the playback control unit 204 sets the start TC into the TC being processed. In this example, 19:01:02.034 is set.

In step S609, the playback control unit 204 initializes the virtual camera 110. Initializing the virtual camera 110 refers to setting the initial values to the position and orientation of the virtual camera 110, which has been described with reference to FIGS. 3A to 3D.

A specific example of the virtual viewpoint image after the initialization of the virtual camera 110 will be described below with reference to FIGS. 7A to 7G.

In step S610, the playback control unit 204 determines whether a playback start instruction is given. The presence or absence of the playback start instruction can be determined based on the toggle state of the playback button 414 illustrated in FIG. 4. If the determination is true (YES in step S610), the processing returns to S601 to start the playback processing. If the determination is false (NO in step S610), the processing returns to step S610 to wait for the playback start instruction.

A playback example of the virtual viewpoint image using the foregoing flowchart will now be described with reference to FIGS. 7A to 7G.

### Playback Example of Virtual Viewpoint Image

The display examples in the case of using the playback processing of the virtual viewpoint image in FIG. 6 will be described with reference to FIGS. 7A to 7G.

Take a scene of a rugby match as an example. Suppose, as described with reference to FIGS. 5A and 5B, that the entire rugby match is captured, and a scoring scene therein is used for a demonstration at an exhibition.

With the start TC of the scoring scene as 19:10:02.034 and the end TC as 19:10:31.020, each user at the exhibition views the virtual viewpoint image therebetween.

An example of display during operation and viewing by user A will initially be described with reference to FIGS. 7A to 7C.

The device is then passed to user B who is next in line. An example of display during the operation and viewing by user B will be described with reference to FIGS. 7E to 7G. While two users are taken as an example to describe the playback processing including the handling during a user change, the playback processing is obviously not limited to two users, and can be repeatedly applied in a similar manner regardless of how many users are lined up.

FIGS. 7A to 7G illustrate the operation screen 401 of the image display apparatus 104 described with reference to FIG. 4 and the virtual viewpoint image displayed thereon.

FIG. 7A illustrates the state when user A starts operation, illustrating the virtual viewpoint image at the start TC where the position and orientation of the virtual camera 110 are set to the initial values. In the flowchart of FIG. 6, the start TC is set in step S607, and the position and orientation of the virtual camera 110 are initialized in step S608. In FIG. 7A, the initial values of the position and orientation of the virtual camera 110 are such that the virtual camera 110 is located outside a long side of the field and oriented to view the subject slightly from the right.

After FIG. 7A, user A can freely operate the virtual camera 110 to view the virtual viewpoint image between the start TC and the end TC. This corresponds to the processing of steps S602 and S603. FIG. 7B will be described as an example.

FIG. 7B illustrates the virtual viewpoint image of a scene where an offload pass (pass by a player just before tackled down) is made. In the diagram, user A operates the virtual camera 110 to view the subject from above (in the Z direction).

The TC in FIG. 7B is 19:10:20.014, for example. User A can similarly freely move the position and orientation of the virtual camera 110 to view the subject from various angles between the start TC and the end TC.

FIG. 7C illustrates the virtual viewpoint image at the end TC. FIG. 7C illustrates a scene where a try is scored in rugby. User A operates the virtual camera 110 to view the subject somewhat from the left from above the long side of the field. If the TC is determined to be the end TC in step S604, step S605 is not performed. The TC is therefore not counted up any further, and in step S607, the screen is switched to display a stop indication in FIG. 7D.

FIG. 7D illustrates an example of the stop screen. While the playback stop is displayed, operations input to the virtual camera 110 are disabled. User A can thereby figure out that his/her operation time is up and pass the device to the next user B or return the device to its original position.

The stop screen is not limited thereto, and any screen may be used that indicates that the playback is stopped or the device is on standby for a playback instruction. Such a message may be displayed onscreen.

Next, the operation of user B will be described.

FIG. 7E illustrates the state when user B starts operation, illustrating the virtual viewpoint image at the start TC where the position and orientation of the virtual camera 110 are set to the initial values. In the flowchart of FIG. 6, the start TC is set in step S608, and the position and orientation of the virtual camera 110 are initialized in step S609. The screen is the same as that of FIG. 7A. It can be seen that the operation state of the virtual camera 110 at the end of operation of the previous user in FIG. 7C has been reset. This shows that the same state can be provided at the start of operation of each user at the exhibition by the processing of steps S608 and S609.

After FIG. 7E, user B can also freely operate the virtual camera 110 and view the virtual viewpoint image between the start TC and the end TC. The operations during this period differ user by user. FIG. 7F will be described as an example.

FIG. 7F illustrates the virtual viewpoint image at the same TC of 19:10:20.014 as in FIG. 7B. The virtual camera 110 is located outside the long side of the field and oriented to view the subject somewhat from the left.

Such a position and orientation of the virtual camera 110 are different from those at the same timecode in FIG. 7B. While the start TC and the end TC are common for all users, the playback processing enables each user to freely operate the virtual viewpoint image during the period.

FIG. 7G illustrates the virtual viewpoint image at the end TC. The TC is the same as in FIG. 7C. The virtual viewpoint image is such that the virtual camera 110 is located outside the other long side of the field and oriented to view the subject somewhat from the left.

In the diagram, user B ends the viewing. As with the previous user, the TC is not counted up any further, and the screen display is switched to the stop indication of FIG. 7D. The subsequent processing is repeated as described above, and can be repeatedly applied even when a large number of users visit the exhibition.

Through the foregoing processing, when a large number of users successively view the virtual viewpoint image on a single device at an exhibition, the waiting queue can be smoothly proceeded and the users can operate the appropriate virtual camera for efficient and satisfactory demonstration. Moreover, the staff's effort to initialize the virtual viewpoint image can be reduced.

In the present exemplary embodiment, the main slider 412 displays the progress across all the timecodes of the captured data, and the sub slider 413 displays a portion of the entire timecodes in an enlarged manner. However, further enhancements may be made to suit the exhibition. For example, the main slider 412 is configured so that the user can select only viewable scenes. Here, the main slider 412 highlights the viewable scenes in the entire timecode interval to show that only those scenes are selectable, and dimly displays the other intervals to show that those intervals are not selectable. The sub slider 413 is configured so that the left end represents the start TC of a viewable scene and the right end represents the end TC of the viewable scene. This enables the user to intuitively select a viewable scene and facilitates selecting an instance that he/she particularly wants to view in the scene.

A second exemplary embodiment describes a case where the playback processing of the virtual viewpoint image described in the first exemplary embodiment includes repeat processing. The repeat processing refers to processing where the same user plays back a scene from a predetermined start TC to a predetermined end TC a plurality of times. In the present exemplary embodiment, such processing may also be referred to as repeat playback. The repeat playback is desirable in experiencing a virtual viewpoint image. The reason is that the experience of viewing the same scene from different angles can be provided, and the user can easily appreciate that the virtual viewpoint image can be viewed from desired points of view regardless of the positions of the actual cameras.

Using the virtual viewpoint image generation system 100 of FIGS. 1A and 1B and the image display apparatus 104 of FIGS. 2A and 2B described in the first exemplary embodiment, only the playback processing of the virtual viewpoint image including the repeat processing will be additionally described.

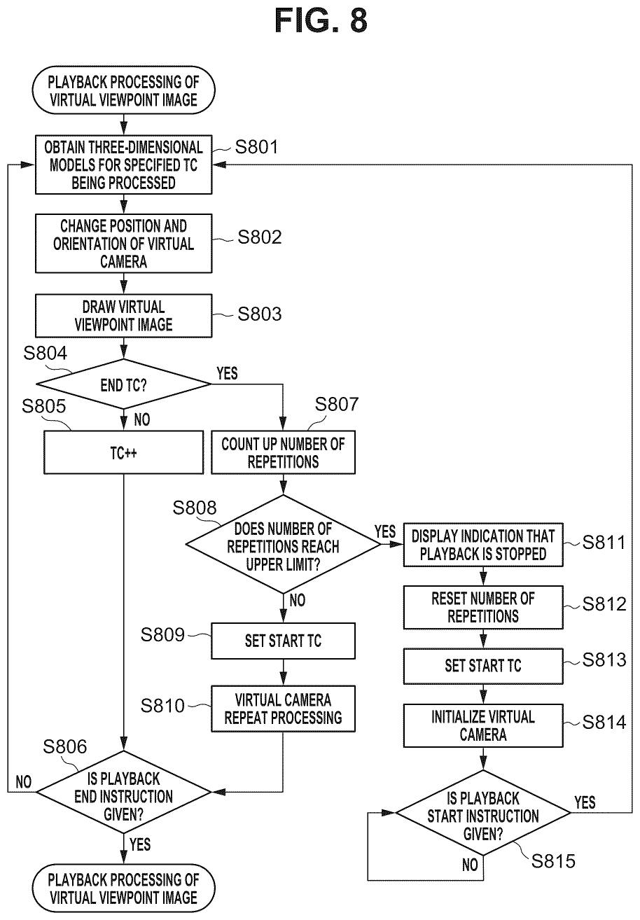

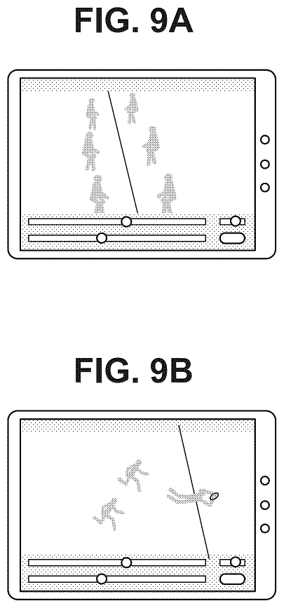

FIG. 8 illustrates the playback processing of the virtual viewpoint image according to the present exemplary embodiment. FIGS. 9A and 9B illustrate a playback example thereof.

### (Playback Processing of Virtual Viewpoint Image)

The playback processing of the virtual viewpoint image according to the present exemplary embodiment will be described with reference to the flowchart of FIG. 8.

This processing is executed by the playback control unit 204 in the block diagram of FIG. 2A via other processing units.

The start TC and the end TC are the same as in the first exemplary embodiment. The framerate-related processing is also similar to that of the first exemplary embodiment, and a description thereof will thus be omitted.

The flowchart of FIG. 8 includes steps S801 to S815. Steps S801 to S803, S805, and S806 are similar to steps S601 to S603, S605, and S606 of FIG. 6 that is the flowchart according to the first exemplary embodiment. A description thereof will thus be omitted. Moreover, steps S813 to S815 are similar to steps S608 to S610, and a description thereof will be omitted.

Steps S804 and S807 to S815 will now be described in order.

In step S804, the playback control unit 204 determines whether the TC being processed is the end TC.

If the determination is false (NO in step S804), the processing proceeds to step S805 and the user continues viewing without changing the position or orientation of the virtual camera 110. If the determination is true (YES in step S804), the processing proceeds to step S807 to determine the number of repetitions made by the user.

In step S807, the playback control unit 204 counts up the number of repetitions.

In step S808, the playback control unit 204 determines whether the number of repetitions reaches its upper limit.

If the determination is false (NO in step S808), the processing proceeds to step S809. If the determination is true (YES in step S808), the processing proceeds to step S811.

In step S809, the playback control unit 204 sets the start TC into the TC being processed. In this example, 19:01:02.034 is set.

In step S810, the playback control unit 204 performs virtual camera repeat processing.

The virtual camera repeat processing refers to processing for controlling whether to maintain the position and orientation of the virtual camera 110 or set the initial values, depending on the state of the initialization setting button 415 illustrated on the operation screen 401 of FIG. 4. The initialization setting button 415 is a toggle button to set whether to maintain or initialize the position and orientation.

The present exemplary embodiment mainly deals with a case where the initialization setting button 415 is set to maintain the position and orientation.

If the initialization setting button 415 is set to maintain the position and orientation, then in step S810, the playback control unit 204, despite the start TC being set in the previous step, maintains the position and orientation of the virtual camera 110 without initializing the virtual camera 110. A specific example of the case where the position and orientation of the virtual camera 110 are maintained will be described below.

In step S811, the playback control unit 204 displays an indication that the playback is stopped on the display unit of the image display apparatus 104. A display example is similar to that described with reference to FIG. 7D of the first exemplary embodiment. When this processing is applied in exhibitions, the operation is switched to the next user in this step.

In step S812, the playback control unit 204 resets the number of repetitions to zero.

When this processing is applied in exhibitions, the number of repetitions is counted up for each user and reset to zero at timing when users are switched.

In other words, the repeat playback refers to the process where the same user, after a playback from the start TC to the end TC, returns to the start TC and performs the playback processing while maintaining the position and orientation of the virtual camera 110. When at least two playbacks are completed, the same user ends the playback and the number of repetitions is reset.

A playback example of the virtual viewpoint image using the foregoing flowchart will now be described with reference to FIGS. 9A and 9B. (Playback Example of Virtual Viewpoint Image)

Display examples in using the playback processing of the virtual viewpoint image illustrated in FIG. 8 will be described with reference to FIGS. 9A and 9B.

For example, suppose, like the first exemplary embodiment, that a scoring scene in a rugby match is used for demonstrations at an exhibition.

The start TC of the scoring scene is 19:10:02.034, and the end TC is 19:10:31.020. Each user at the exhibition views the virtual viewpoint image therebetween.

For the purpose of description, suppose that there are two users, namely, user A and user B. It will be understood that the playback processing is not limited to two users and can be repeatedly applied in a similar manner regardless of how many users are lined up.

The present exemplary embodiment includes the repeat playback. For example, the number of repetitions is two. The number of repetitions is not limited to two, either, and can be changed depending on how crowded the exhibition is.

An example of operation and viewing by user A will initially be described. Suppose that the first repeat playback by user A is similar to FIGS. 7A to 7C described in the first exemplary embodiment. FIG. 7C illustrates the virtual viewpoint image at the end TC where the first repeat playback is completed. The processing proceeds from step S804 to steps S807 and S808. Since the number of repetitions here is one and yet to reach the upper limit, the processing proceeds to step S809 to set the start TC. In the virtual camera repeat processing of step S810, the position and orientation of the virtual camera 110 are maintained. FIG. 9A illustrates the virtual viewpoint image here. FIG. 9A illustrates the case where the position and orientation of the virtual camera 110 are the same as in FIG. 7C at the previous end TC, i.e., the virtual camera 110 is located outside the long side of the field and oriented to view the subject somewhat rightward. Alternatively, only the position may be restored to the initial position while the orientation is maintained as in FIG. 7C. The reason is that in sports where the playing field is large like rugby, the position of the virtual camera 110 at the start TC and that of the virtual camera 110 at the end TC can be significantly far apart.

In the next repeat playback, user A can then freely operate the virtual camera 110 again until the end TC. FIG. 9B illustrates the virtual viewpoint image at the end TC. The virtual camera 110 here is located outside the other long side of the field and oriented to view the subject somewhat leftward. After the end TC of FIG. 9B, the processing proceeds to steps S807 and S808. Since the number of repetitions is two and has reached the upper limit, the processing proceeds to step S811. The screen display transitions to the same stop display as in FIG. 7D.

The image display apparatus 104 is then passed to the next user B. Since the TC and the virtual camera 110 are initialized in steps S813 and S814 while the stop screen of FIG. 7D is displayed, the screen when user B starts operation is the same as in FIG. 7E.

The determination condition as to whether to transition to the stop display in step S808 does not need to be the number of repetitions, and the determination may be made based on whether the playback time of the user exceeds a predetermined total playback time. Alternatively, the determination may be made based on whether the cumulative operation time of the virtual camera 110 exceeds a predetermined time.

If, in step S810 of FIG. 8, the initialization setting button 415 is set to initialization, the virtual camera 110 is initialized after a playback from the start TC to the end TC like the first exemplary embodiment even during the repeat playback of a single user.

Through the foregoing playback processing of the virtual viewpoint image, when a large number of users take turns to repeat playing back the virtual viewpoint image on a single device at an exhibition, the waiting queue can be smoothly proceeded. Moreover, the users can operate the appropriate virtual camera for efficient and satisfactory demonstration.

### Other Exemplary Embodiments

An exemplary embodiment of the present disclosure can also be carried out through processing for supplying a program for implementing one or more functions of the foregoing exemplary embodiments to a system or an apparatus via a network or a storage medium, and reading and executing the program by one or more processors in a computer of the system or apparatus.

A circuit for implementing one or more functions (for example, ASIC) can also be used for implementation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-166367, filed Sep. 27, 2023, which is hereby incorporated by reference herein in its entirety.

What is claimed is:

1. A playback apparatus comprising:
one or more memories storing instructions; and
one or more processors executing the instructions to:
play back a virtual viewpoint image from a predetermined start timecode to a predetermined end timecode, the virtual viewpoint image being generated using three-dimensional shape data generated from images captured from a plurality of positions and virtual viewpoint information;
control the virtual viewpoint information; and
initialize timecode of the virtual viewpoint image to the predetermined start timecode in response to an end of playback of the virtual viewpoint image,
wherein the virtual viewpoint information is controlled differently in playing back the virtual viewpoint image and in initializing the timecode.

2. The playback apparatus according to claim 1, wherein the one or more processors further executing the instructions to, in a case where the timecode of the virtual viewpoint image is to be initialized, pause the playback of the virtual viewpoint image and display an indication that the playback of the virtual viewpoint image is in a paused state.

3. The playback apparatus according to claim 1, wherein the one or more processors further executing the instructions to, in a case where the timecode of the virtual viewpoint image is to be initialized, set predetermined values to a position and orientation of a virtual point of view included in the virtual viewpoint information.

4. The playback apparatus according to claim 1, wherein the one or more processors further executing the instructions to:
accept an operation made by a user;
in a case where the virtual viewpoint image is being played back, control the virtual viewpoint information based on the accepted operation; and
in a case where the timecode of the virtual viewpoint image is to be initialized, control the virtual viewpoint information without being based on the accepted operation.

5. The playback apparatus according to claim 1, wherein the one or more processors further executing the instructions to, in a case where the virtual viewpoint image is to be repeatedly played back, control the virtual viewpoint information differently in repeating playing back the virtual viewpoint image and in initializing the timecode of the virtual viewpoint image.

6. The playback apparatus according to claim 1, wherein the one or more processors further executing the instructions to, in a case where the virtual viewpoint image is to be repeatedly played back, initialize the timecode of the virtual viewpoint image in response to a fact that the virtual viewpoint image is repeatedly played back a predetermined number of times.

7. The playback apparatus according to claim 1, wherein the one or more processors further executing the instructions to, in a case where the virtual viewpoint image is to be repeatedly played back, initialize the timecode of the virtual viewpoint image in response to a fact that the virtual viewpoint image is played back for a predetermined time.

8. A control method of a playback apparatus, comprising:
playing back a virtual viewpoint image from a predetermined start timecode to a predetermined end timecode, the virtual viewpoint image being generated using three-dimensional shape data generated from images captured from a plurality of positions and virtual viewpoint information;
controlling the virtual viewpoint information; and
initializing timecode of the virtual viewpoint image to the predetermined start timecode in response to an end of playback of the virtual viewpoint image,
wherein the virtual viewpoint information is controlled differently in playing back the virtual viewpoint image and in initializing the timecode.

9. A non-transitory recording medium on which a program for causing a playback apparatus to perform a control method, the control method comprising:
playing back a virtual viewpoint image from a predetermined start timecode to a predetermined end timecode, the virtual viewpoint image being generated using three-dimensional shape data generated from images captured from a plurality of positions and virtual viewpoint information;
controlling the virtual viewpoint information; and
initializing timecode of the virtual viewpoint image to the predetermined start timecode in response to an end of playback of the virtual viewpoint image,
wherein the virtual viewpoint information is controlled differently in playing back the virtual viewpoint image and in initializing the timecode.
